(19) United States
(12) Patent Application Publication
(10) Pub. No.: US 2012/0128875 A1
(43) Pub. Date: May 24, 2012

(54) Method for Producing an Inlet Lining

(76) Inventor: Andre Werner, Munich (DE)

(21) Appl. No.: 13/300,385

(22) Filed: Nov. 18, 2011

Related U.S. Application Data
(63) Continuation of application No. 12/093,395, filed on Aug. 29, 2008, now abandoned.

(30) Foreign Application Priority Data
Nov. 19, 2005 (DE) 102005055200.5

(51) Int. Cl. B05D 7/22

(52) U.S. Cl. 427/181

(57) ABSTRACT

The invention relates to a method for producing an inlet lining on a stator-sided component of a turbine engine, in particular, a gas turbine, with at least the following steps: providing a stator-sided component of a turbine engine with an inlet lining; providing a mixture consisting of a solvent, particles of a metallic parent material for the inlet lining, the particles being insoluble in the solvent, and a filler having at least one constituent soluble in the solvent; applying the mixture to the stator-sided component; drying the stator-sided component and the mixture applied to the component while at least partially expelling the solvent to provide a porous green body in the area of the applied and dried mixture; and diffusion heat treating the component for inwardly diffusing aluminum and/or chromium and for forming the intermetallic phases in the resulting inlet lining.

### RELATED APPLICATIONS

This application is a continuation of U.S. patent application Ser. No. 12/093,395, having a filing date of Aug. 29, 2008, which is a 371 National Stage Application of International Application No. PCT/DE2006/001973 (International Publication Number WO/2007/056979), having an International filing date of Nov. 10, 2006 entitled “Verfahren zum Herstellen eines Einlaufbelags” (“Method for Producing an Inlet Lining”). International Application No. PCT/DE/2006/001973 claimed priority benefits, in turn, from German Patent Application No. 10 2005 055 200.5, filed Nov. 19, 2005. International Application No. PCT/DE/2006/001973 and German Patent Application No. 10 2005 055 200.5 are hereby incorporated by reference in their entireties.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The invention relates to a method for producing an inlet lining on a stator-sided component of a turbine engine.

Turbine engines, such as gas turbines, usually comprise a plurality of rotating rotor blades and a plurality of stationary guide vanes. In this case the rotating rotor blades rotate together with a rotor; and the rotating rotor blades and the guide vanes are enclosed by a stationary housing. In order to increase the performance, it is important to optimize all components and subsystems. This also includes the so-called sealing systems. In the case of turbine engines, maintaining a minimum gap between the rotating rotor blades and the stationary housing of a high pressure compressor poses a special problem. In particular, high pressure compressors experience the highest absolute temperatures and temperature gradients, a feature that renders the maintenance of a gap of the rotating rotor blades in relation to the stationary housing difficult. The reason lies, inter alia, in the fact that compressor rotor blades dispense with shrouds, as used in the case of turbine rotor blades.

As stated above, rotor blades in compressors do not exhibit a shroud. Therefore, upon so-called rubbing against the stationary housing, the ends or rather the tips of the rotor blades are exposed to a direct friction contact with the housing. This type of rubbing of the tips of the rotor blades against the housing is induced by the manufacturing tolerances when setting a minimum radial gap. Since the friction contact causes the tips of the rotor blades to be abraded at the same material, an undesired increase in the gap may occur over the entire periphery of the housing and the rotor. In order to avoid this increase, the ends or rather the tips of the rotor blades are armored with a hard lining or with abrasive particles, as already known from the state of the art.

Another possibility of avoiding wear and tear at the tips of the rotor blades and to provide for an optimal seal between the ends or rather the tips of the rotor blades and the stationary housing consists of coating the housing with a so-called inlet lining. When the material of an inlet lining is abraded, the radial gap does not increase over the entire periphery, but rather, as a rule, only in the shape of a sickle. As a result, a reduction in the engine performance is avoided. Housings with an inlet lining are known from the state of the art.

U.S. Pat. No. 6,660,405 B2 discloses an inlet lining, which is intended for gas turbine components and is made of three components. In this case the disclosed inlet lining exhibits, as a first component, a metallic, oxidation-resistant matrix phase comprising an MCrAlY material, where M is a metal, for example, iron, chromium, nickel or cobalt, Cr is chromium, Al is aluminum and Y is yttrium; as the second component, an intermetallic phase comprising preferably β-NiAl (beta nickel aluminum); and, as the third component, pores, created by burning off polyester or polyimide. The inlet lining, disclosed in U.S. Pat. No. 6,660,405 B2, may or may not comprise, as the fourth component, ceramic particles, such as particles composed of hexagonal boron nitride.

According to U.S. Pat. No. 6,660,405 B2, this type of inlet lining is manufactured by producing a mixture comprising the metallic MCrAlY material, the intermetallic β-NiAl material and polyester or polyimide. Then this mixture is applied by thermal spraying to the component to be provided with the inlet lining According to this state of the art, an intermetallic β-NiAl material is used directly in the production of the mixture to be applied to the component.

### BRIEF SUMMARY OF THE INVENTION

Against this background, the present invention is based on the problem of providing a novel method for producing an inlet lining.

This problem is solved by a method for producing an inlet lining in the sense of claim 1. The inventive method comprises at least the following steps: a) providing a stator-sided component of a turbine engine, this component being provided with an inlet lining; b) providing a mixture consisting of a solvent; particles of a metallic parent material for the inlet lining, said particles being insoluble in the solvent; and a filler, this filler having at least one constituent that is soluble in the solvent; c) applying the mixture to the stator-sided component; d) drying the stator-sided component and the mixture, applied to the component, while at least partially expelling the solvent in order to provide a porous green body in the area of the applied and dried mixture; e) diffusion heat treating the component for inwardly diffusing aluminum and/or chromium and for forming the intermetallic phases in the resulting inlet lining.

### BRIEF DESCRIPTION OF SEVERAL VIEWS OF THE DRAWINGS

[Not Applicable]

### DETAILED DESCRIPTION OF THE INVENTION

According to the inventive method for producing an inlet lining, the intermetallic phase of this inlet lining is provided by inwardly diffusing the aluminum and/or chromium into the inlet lining of the component by means of diffusion heat treatment. Therefore, during the production of the mixture the present invention, described here, does not use an intermetallic material, but rather the intermetallic phase of the inlet lining is provided by way of a diffusion heat treatment.

Furthermore, an advantageous further development of the invention provides that in step b) an additional substance, which is insoluble in the solvent, is introduced into the mixture. In this case the additional substance is decomposed and/or burned off during the diffusion heat treatment in order to create a macro-porosity in the inlet lining that forms. Furthermore, in step b) ceramic particles, which are insoluble in the solvent, may be introduced into the mixture.

Preferred further developments of the invention are disclosed in the dependent claims and the following description.

The present invention, described here, relates to a method for producing an inlet lining on a stator-sided component of a turbine engine, in particular on a component of a housing of a gas turbine aircraft engine.

The inventive method is subdivided into five main steps. The first main step provides a stator-sided component of a turbine engine, said component being provided with an inlet lining. A second main step provides a mixture, said mixture consisting of at least a solvent; particles of a metallic parent material for the inlet lining, said particles being insoluble in the solvent; and a filler, which exhibits at least one constituent that is soluble in the solvent. In a subsequent third main step, the mixture is applied to the stator-sided component, and, in particular, in a section, in which the inlet lining is supposed to be provided. Thereupon in a fourth main step the stator-sided component and the mixture, applied to the component, are dried. In this drying process the solvent is expelled at least partially from the applied mixture while at the same time forming a porous green body, resulting in the area of the applied mixture. Thereupon in a fifth main step of the inventive method aluminum and/or chromium is/are inwardly diffused by way of a diffusion heat treatment in order to provide in this way an intermetallic phase in the resulting inlet lining.

In the process of providing the mixture in the second main step of the inventive method, a mixture is provided, as stated above. This mixture comprises at least one solvent; particles of the metallic parent material for the inlet lining, said particles being insoluble in the solvent; and the filler, which exhibits at least one constituent that is soluble in the solvent. The solvent is, in particular, water. The particles, which are insoluble in the solvent and which are intended for the metallic parent material of the inlet lining, are preferably powdery MCrAlY particles. The filler is, in particular, polyvinyl alcohol or methyl cellulose ester.

In addition to the above constituents of the mixture, an additional substance, which is insoluble in the solvent, may be introduced into the mixture. In this case the additional substance is decomposed and/or burned off during the diffusion heat treatment in the fifth main step of the inventive method. This additional substance is preferably a polymer, like polyester or polyimide, which upon burning off creates a macro-porosity in the inlet lining. It must be pointed out that the inlet lining is provided with a porosity as early as during the removal of the solvent by evaporation. In this case, however, the resulting pores are smaller; and, thus, the process involves a micro-porosity.

Another advantageous further development of the invention provides that in the second main step of the inventive method—in providing the mixture—ceramic particles are introduced into the mixture. The ceramic particles may be particles composed of hexagonal boron nitride, graphite or clay mineral. Furthermore, CaO (calcium oxide) particles and/or MgO (magnesium oxide) particles may be used as the ceramic particles. Then, if NiC (nickel carbide) particles are used as the parent material for the inlet lining in the mixture, preferably ceramic particles composed of graphite are added to the mixture. Then, in contrast, if NiCrAl (nickel chromium aluminum) particles are used as the parent material for the inlet lining in the mixture, then ceramic particles composed of clay mineral are introduced into the mixture. Then, in contrast, if nickel-based alloy particles or aluminum based alloy particles or cobalt based alloy particles are used as the parent material for the inlet lining in the mixture, ceramic particles composed of hexagonal boron nitride may be introduced into the mixture.

The mixture, which is provided in the second main step, is either a highly liquid, slip-like mixture or a viscous, pasty mixture.

In the third main step of the inventive method, the mixture, produced as a highly liquid slip or viscous paste, is applied to the area of the stator-sided component, on which the inlet lining is to form, by brushing or immersion or spraying.

As an alternative, the mixture, which is provided in the second main step of the inventive method, may also be provided as a highly viscous, tape-like molded article. Then in the third main step of the inventive method, this tape-like molded article is cemented on the area of the stator-sided component, on which the inlet lining is to be formed.

Upon applying the mixture to the component, the drying of the stator-sided component and the applied mixture takes place at a maximum temperature of 100 deg. C. in the fourth main step. In this case the drying is carried out preferably at room temperature. In the drying process the solvent is expelled at least partially from the mixture, so that a porous—that is, micro-porous—green body is formed in the area of the applied and dried mixture. The constituent of the filler, said constituent being soluble in the solvent, serves as the binder for the green body.

After the drying process, the fifth main step of the inventive method provides a diffusion heat treatment in the sense of a diffusion annealing in order to create an intermetallic phase in the inlet lining through inwards diffusion of aluminum and/or chromium. At the same time an intermetallic phase consisting of β-NiAl is preferably formed. Consequently this intermetallic phase is the result of the heat diffusion treatment and exists, therefore, only to some extent in stoichiometric form.

The inlet lining, which is provided in this way, exhibits a metallic phase consisting preferably of a MCrAlY material. In this case the metallic phase provides the base structure of the inlet lining and serves to attach the stator-sided component. Furthermore, the inlet lining exhibits an intermetallic phase, which serves to impart a brittle character to the material at the connecting points of the individual particles in the inlet lining, thus improving the inlet capacity of the inlet lining.

Furthermore, the intermetallic phase enhances the oxidation resistance of the inlet lining Furthermore, the porosity of the inlet lining optimizes the inlet capacity of the same. Owing to the introduction of the ceramic particles, the detachment of the particles when the rotor blades rub against the inlet lining may be controlled.

The invention has now been described in such full, clear, concise and exact terms as to enable any person skilled in the art to which it pertains, to practice the same. It is to be understood that the foregoing describes preferred embodiments and examples of the invention and that modifications may be made therein without departing from the spirit or scope of the invention as set forth in the claims. Moreover, while particular elements, embodiments and applications of the present technology have been shown and described, it will be understood, of course, that the present technology is not limited thereto since modifications can be made by those skilled in the art without departing from the scope of the present disclosure, particularly in light of the foregoing teachings and appended claims. Moreover, it is also understood that the embodiments shown in the drawings, if any, and as described above are merely for illustrative purposes and not intended to limit the scope of the invention, which is defined by the following claims as interpreted according to the principles of patent law, including the Doctrine of Equivalents. Further, all references cited herein are incorporated in their entirety.

1. A method for producing an inlet lining on a stator-sided component of a turbine engine, comprising the following steps:
a) providing a stator-sided component of a turbine engine, the stator-sided component having an inlet lining;
b) providing a mixture comprising:
i) a solvent;
ii) particles of a metallic parent material for the inlet lining, said particles being insoluble in the solvent; and
iii) a filler, having at least one constituent that is soluble in the solvent;
c) applying the mixture to the stator-sided component;
d) drying the stator-sided component and the mixture applied to the component while at least partially expelling the solvent to provide a porous green body in the area of the applied and dried mixture; and
e) diffusion heat treating the component for inwardly diffusing at least one of aluminum or chromium and for forming intermetallic phases in a resulting inlet lining.

2. The method of claim 1, wherein said providing a mixture step further comprises introducing an additional substance, insoluble in the solvent, into the mixture, the additional substance being decomposed and/or burned off during the diffusion heat treatment in order to create a macro-porosity in the resulting inlet lining.

3. The method of claim 2, wherein the additional substance is one of polyester and polyimide.

4. A method as in any either of claim 1 or 2, wherein said providing a mixture step further comprises introducing ceramic particles into the mixture, said ceramic particles being insoluble in the solvent.

5. The method of claim 4, wherein the ceramic particles are composed of at least one of hexagonal boron nitride, graphite, clay mineral, calcium oxide and magnesium oxide.

6. The method of claim 5, wherein nickel carbide particles are used as the parent material for the inlet lining in the mixture and the ceramic particles are composed of graphite.

7. The method of claim 5, wherein nickel chromium aluminum particles are used as the parent material for the inlet lining in the mixture, and the ceramic particles are composed of clay mineral.

8. The method of claim 5, wherein the parent material is at least one of nickel-based alloy particles, aluminum based alloy particles and cobalt based alloy particles, and the ceramic particles are composed of hexagonal boron nitride.

9. The method of claim 1, wherein said mixture is provided as a highly liquid slip and is applied by immersion or spraying.

10. The method of claim 1, wherein said mixture is provided as a viscous paste and is applied by brushing.

11. The method of claim 1, wherein said mixture is provided as a highly viscous, tape-like molded article and is applied by cementing.

12. The method of claim 1, wherein said drying takes place at a maximum temperature of 100 degrees Celsius.

13. The method of claim 12, wherein said drying takes place around room temperature.

14. The method of claim 1, wherein, while expelling at least partially the solvent, a micro-porosity is provided in the area of the applied and dried mixture.

15. The method of claim 1, wherein during the diffusion heat treatment of the component beta nickel aluminum is formed as the intermetallic phase.
